(19) United States
(12) Patent Application Publication
(10) Pub. No.: US 2010/0282101 A1
(43) Pub. Date: Nov. 11, 2010

(54) APPARATUS FOR INTRODUCING SHEET INTO SHEET-FED PRINTING PRESS

(75) Inventor: Shizuo MASUDA, Shizuoka (JP)

Correspondence Address: LADAS & PARRY LLP, 26 WEST 61ST STREET, NEW YORK, NY, 10023, US

(73) Assignee: SHINOHARA MACHINERY CO., LTD.

(21) Appl. No.: 12/770,940

(22) Filed: Apr. 30, 2010

(30) Foreign Application Priority Data
May 7, 2009 (JP) 2009-112497

(51) Int. Cl. B41F 13/24

(52) U.S. Cl. 101/232

(57) ABSTRACT

The present invention aims at an improved apparatus for introducing sheet smoothly into printing unit 10 even in case thickness of sheet is changed without any adjustment.

The present invention premises a sheet-fed printing press whose sheet transfer path for a plurality of printing units 10 in modular fashion is composed of double-sized transfer and impression cylinders.

Apparatus, being disposed between sheet feeder 26 and the first printing unit 10a, for introducing sheet into said sheet-fed printing press comprising;

First double-sized transfer cylinder 30 whose center of rotation is above the transfer path of sheet 24 and has, in succession with gripper means 40 on its circumference, curved guide member 42 which can be depressed in radial direction of the cylinder,
Second transfer cylinder 32 of approximately the same construction with said double-sized impression cylinder 18 and is in contact with the lower portion of said first transfer cylinder 30 and said transfer cylinder 20 of said first printing unit 10a.

### BACKGROUND OF THE INVENTION

1. Field of the Invention

The present invention relates generally to sheet-fed printing press, or more precisely, to apparatus for introducing sheet smoothly into printing unit even in case thickness of sheet is changed without any adjustment.

2. Description of the Prior Art

In sheet-fed printing press by which each color is continuously layered onto standard-size sheet, parts manufacturing as well as machine construction can remarkably be simplified if printing units for each color are in simple modular construction, thereby manufacturing cost will satisfactorily be reduced.

Thickness of sheet for sheet-fed printing press ranges from 0.04 mm (thin sheet) to 1.25 mm (thick sheet), therefore, resilient force of such sheet varies.

Accordingly, it is desirable that, even in case thickness of sheet is changed, such sheet is smoothly introduced into printing unit.

In Japanese patent laid-open No. 2006-289974, a sheet-fed printing press is disclosed in which each printing unit is standardized in a modular fashion with plate cylinder, blanket cylinder, impression cylinder and double-sized transfer cylinder.

But, as the prior art technique does not take into account the change of thickness, any considerable efforts is not made with regard to feeding piled sheet from sheet feeder into the first printing unit.

In Japanese patent laid-open No. 2008-296385 by the same applicant of the present invention, sheet introducing apparatus is disclosed which is mainly composed of a plurality of sheet transfer cylinders.

But, the technique mainly focuses introducing thick sheet smoothly into printing unit without taking into account of the change of thickness.

Further, in Japanese patent laid-open No. 2008-132781, surface of intermediate cylinder which links printing units is composed of support element which is movable in radial direction of the cylinder, thereby, surface configuration of the cylinder can be altered.

Regretfully, manufacturing cost inevitably rises by the prior art technique, because construction and control for moving such support element is excessively complicated.

### SUMMARY OF THE INVENTION

Upon consideration of above-described problems of prior art techniques, apparatus for introducing sheet according to the present invention aims at feeding sheet smoothly into printing unit even in case thickness of sheet is changed without any adjustment.

To achieve the object, apparatus according to the present invention is disposed between sheet feeder and the first printing unit and comprises first double-sized transfer cylinder whose center of rotation is above the transfer path of sheet and has, in succession with gripper means on its circumference, curved guide member which can be depressed in radial direction of the cylinder, second transfer cylinder of approximately the same construction with double-sized impression cylinder and is in contact with the lower portion of first transfer cylinder and transfer cylinder of first printing unit.

By these constructions, total cost of manufacturing the sheet-fed printing press itself as well as sheet introducing apparatus is satisfactorily be reduced. Printing sheet is smoothly introduced even in case thickness of it is changed without any adjustment. Fatal break-down of cylinder due to incorrect sheet feeding such as double feeding can surely be prevented.

The above and other objects of the invention will become apparent from the following description of preferred embodiment taken in conjunction with the accompanying drawings. However, the following description is only an embodiment of the invention and the present invention is not limited to the embodiment.

### BRIEF DESCRIPTION OF THE DRAWINGS

FIG. 1 is a side view partly showing a sheet-fed printing press equipped with an apparatus for introducing sheet according to the present invention.

FIG. 2 is a detailed cross section of a first transfer cylinder which constitutes the sheet introducing apparatus.

FIG. 3 is a partial cross section in which a curved guide member of the first transfer cylinder is depressed into radial direction of the cylinder.

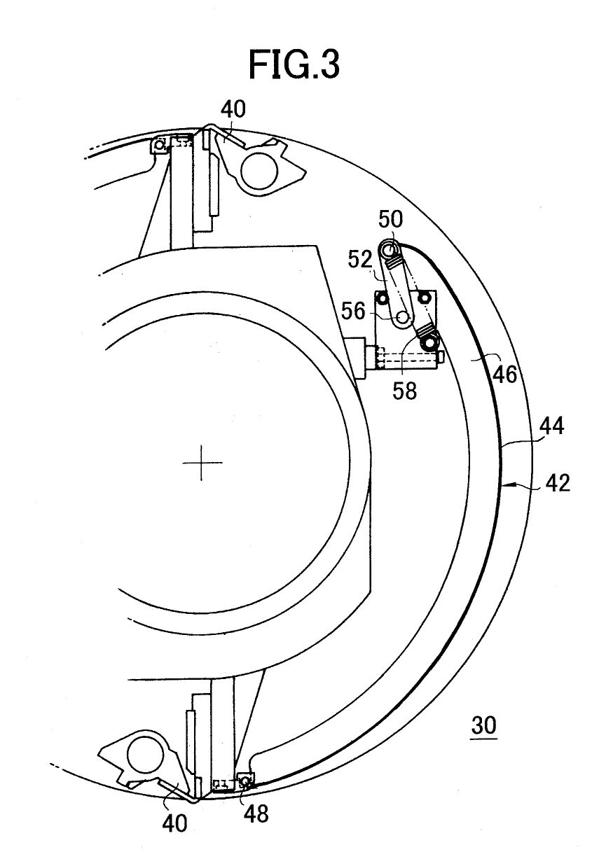

FIG. 4 is a view showing a curved guide member of the first transfer cylinder from an arrow I of FIG. 2 along axial direction of the cylinder.

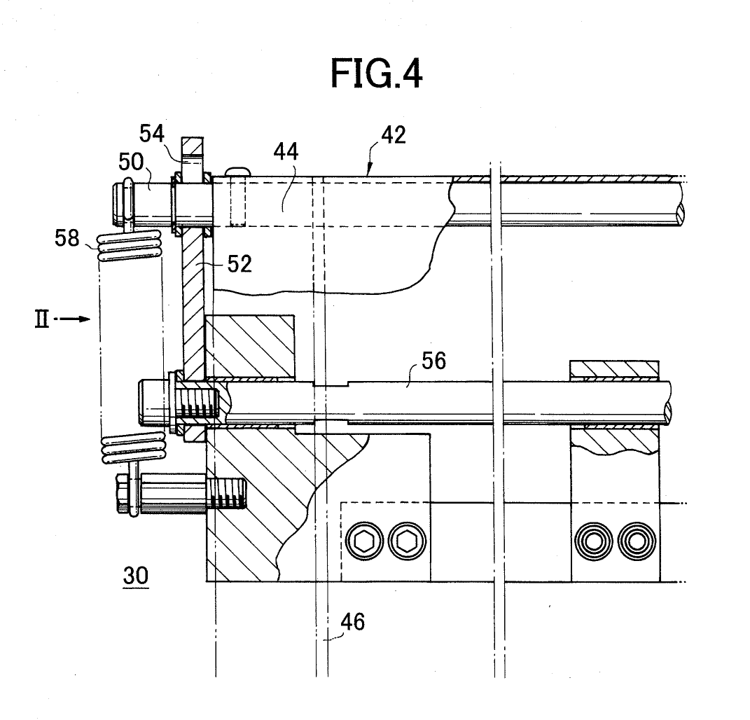

FIG. 5 is an enlarged view from an arrow II of FIG. 4.

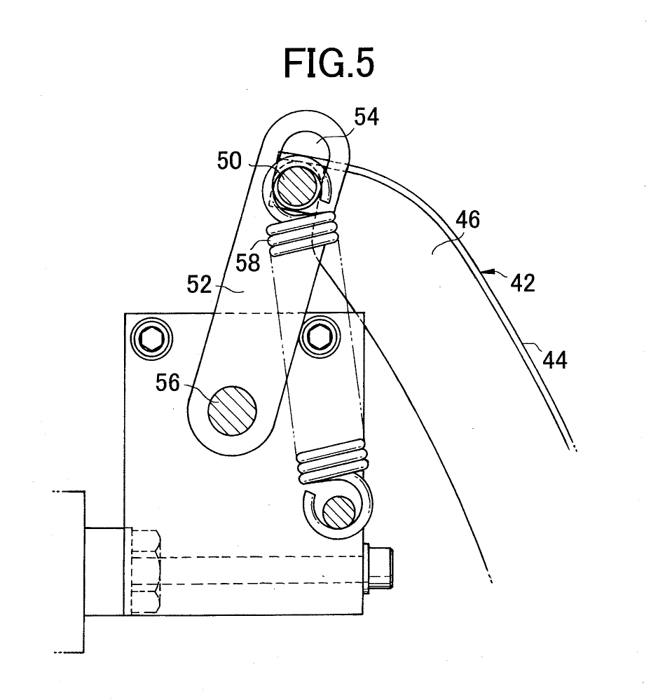

### DESCRIPTION OF THE PREFERRED EMBODIMENT

An embodiment of sheet introducing apparatus according to the present invention will be detailed herein-under with reference to the accompanying drawings.

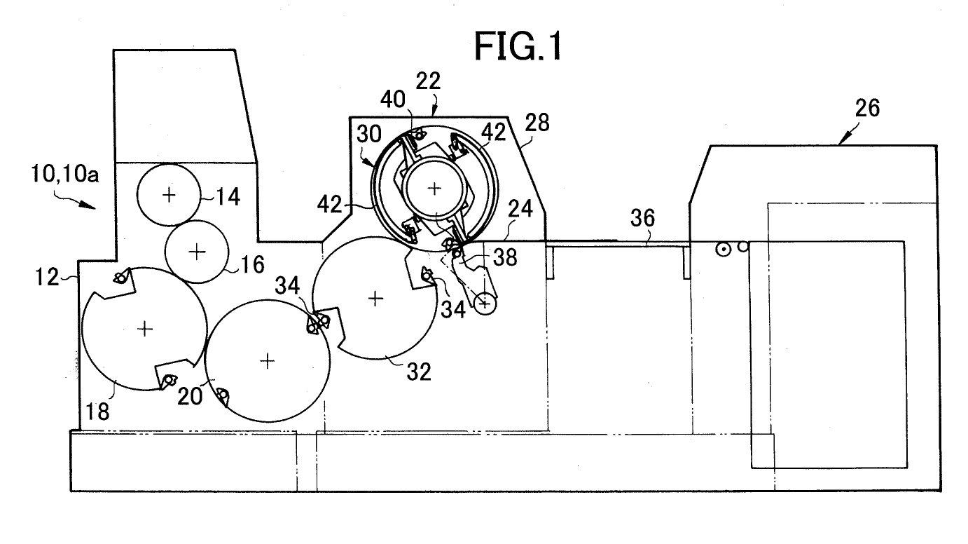

In sheet-fed printing press for continuously layering each color of black, cyan, magenta and yellow onto standard-size sheet, each printing unit 10 is independently prepared in standard modular fashion and side frames 12 on both sides of machine are coupled each other in sheet transfer direction (from right to left in FIG. 1).

As is well known in the art, plate cylinder 14, blanket cylinder 16 and double-sized impression cylinder 18 are rotary supported between both side frames 12 and sheet transfer path is composed by linking printing units 10 with double-sized transfer cylinder 20.

As is commonly used in the field of printing machinery, the term “double-sized” means that cylinder has a diameter twice that of plate cylinder 14. Delivery device for re-piling printed sheet is prepared at downstream in succession to printing units 10, but such device is not shown in the figures, as the present invention solely relates to sheet introducing apparatus 22 at upstream.

Sheet introducing apparatus 22 according to the present invention is in itself a single unit disposed between sheet feeder 26 on which sheet 24 to be printed is piled and first printing unit (especially designated by reference numeral 10a). Likewise each printing unit 10, first and second transfer cylinders 30, 32 are rotary supported by a pair of side frames 28.

Second transfer cylinder 32 at downstream of sheet transfer path has approximately the same construction as double-sized impression cylinder 18 of printing unit. The circumference of the cylinder 32 is partial arc-shaped and has a plurality of gripper means 34. The cylinder 32 transfers sheet 24 in contact with the first transfer cylinder 30 of sheet introducing apparatus 22. Consequently, all path for sheet transfer is entirely composed of double-sized cylinders, thereby reducing, to the utmost, bending force which is troublesome for thick sheet.

As to the first transfer cylinder 30, piled sheet 24 is separated by sheet feeder 26 one by one and is transferred from sheet feeder 26 onto feeder board 36 in shingle-like manner. Then, front end of sheet 24 is gripped by swing gripper 38 of sheet introducing unit 22. The first transfer cylinder 30 takes up front end of sheet 24 from swing gripper 38 which swings in synchronism with machine speed. The cylinder 30 is just the first cylinder around which sheet 24 rolls gradually. In other words, the sheet 24 is changed from plane state into curved one by the first transfer cylinder 30. Therefore, it is an important point in sheet transfer from the standpoint to prevent bad influence due to resilient force.

Gripper means 40 are arranged in parallel to cylinder axis at the circumference of double-sized transfer cylinder 30 and, as is well known in the art, are driven synchronously by cam.

Curved guide member 42 forms an outline of cylinder in succession to gripper means 40. Compared with the fixed circumference of second transfer cylinder 32, that of curved guide member 42 can be depressed in radial direction of the cylinder (that is to say, in the direction of center of cylinder.).

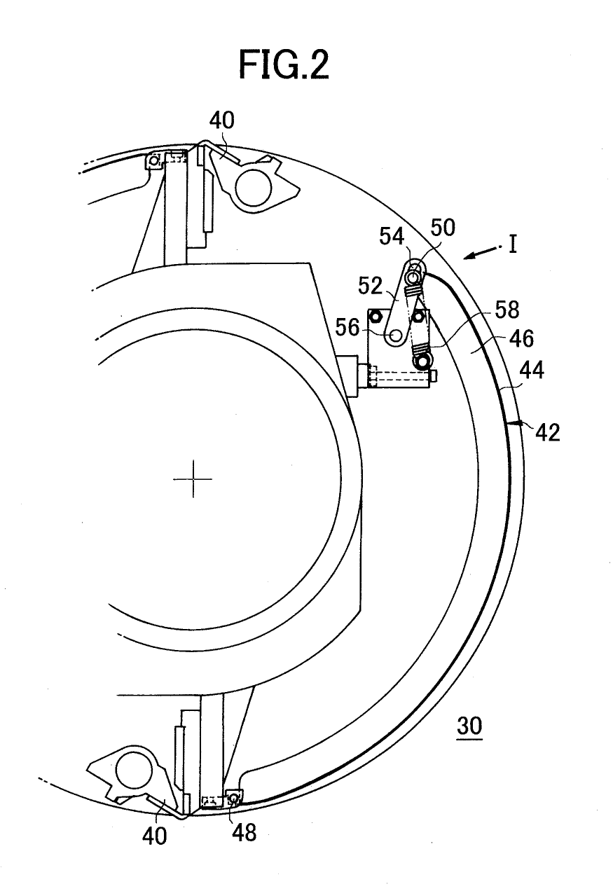

As shown in detail in FIG. 2 and so forth, curved guide member 42 comprises curved plate 44 and ribs 46. The section of curved plate 44 is partial arc-shaped and the plate 44 extends in axial direction of cylinder. A number of ribs 46 are attached so as to reinforce curved plate 44. Gripper means 40 side of curved guide member 42 near front end of sheet 24 is movably joined to the cylinder by way of shaft 48. The other side corresponding to rear end of sheet 24 is in conjunction with long slit 54 of link member 52 by way of other shaft 50. Other end of link member 52 opposite to long slit 54 is movably joined to the cylinder by way of further shaft 56. Link member 52 is always forced by spring member 58 which is connected to shaft 50 in radial direction from center of cylinder.

Accordingly, portion of curved guide member 42 corresponding to rear end of sheet 24 is forced in radial direction so that guide member 42 forms outline of cylinder. But, once incorrect sheet feeding such as double feeding occur, the portion is depressed into the center of cylinder against force of spring member 58 on account of thickness of sheet 24. The degree of such depression increases in the lower stream of cylinder due to support by way of link member 52. Fatal accident tends to occur in such lower phase of rotation after gripper means 40.

As described before, first transfer cylinder 30 is exactly the first cylinder on which sheet 24 rolls. The circumference of cylinder 30 is transformable, because the cylinder 30 is of vital importance against incorrect sheet feeding.

A number of sensors are prepared in printing press for watching incorrect sheet feeding. Even if such sensors can detect incorrect sheet feeding and issue signals to emergently stop printing press, there are inevitably time lag before further sheet feeding is really stopped. But, in accordance with the present invention, the cylinder itself can be deformed just due to such incorrect sheet feeding on the very start of incorrect sheet feeding, thereby fatal damage to cylinder can be evaded.

Even in case thickness of sheet is changed, any particular adjustment is not needed, as first transfer cylinder 30 deforms by itself. It is not practical to totally skeletonize first transfer cylinder 30, because there is not any guide for, especially thin sheet.

According to the present invention, first transfer cylinder where sheet transfer changes from plane state into curved one is deformable by simple construction. Thereby, any particular adjustment is not needed even in case thickness of sheet is changed. Fatal damage to cylinder by incorrect sheet feeding can be prevented as well. The invention is of importance for maintenance of sheet-fed printing press.

The present invention is not limited to the embodiment described above; it can be extended and modified variously.

### DESCRIPTION OF THE REFERENCE NUMERALS

10 printing unit
10a first printing unit
18 pressure cylinder
20 transfer cylinder
22 sheet introducing apparatus
24 sheet
26 sheet feeder
30 first transfer cylinder
32 second transfer cylinder
40 gripper means
42 curved guide member
44 curved plate
46 rib
52 link member
58 spring member

What is claimed is:

1. In a sheet-fed printing press whose sheet transfer path for a plurality of printing units 10 in modular fashion is composed of double-sized transfer and impression cylinders 20, 18;
Apparatus, being disposed between sheet feeder 26 and the first printing unit 10a, for introducing sheet into said sheet-fed printing press comprising;
First double-sized transfer cylinder 30 whose center of rotation is above the transfer path of sheet 24 and has, in succession with gripper means 40 on its circumference, curved guide member 42 which can be depressed in radial direction of the cylinder,
Second transfer cylinder 32 of approximately the same construction with said double-sized impression cylinder 18 and is in contact with the lower portion of said first transfer cylinder 30 and said transfer cylinder 20 of said first printing unit 10a.

2. Apparatus for introducing sheet according to claim 1, wherein degree of depression of said curved guide member 42 in radial direction of said first transfer cylinder 30 increases along lower stream of rotation of cylinder.

3. Apparatus for introducing sheet according to claim 2, wherein said curved guide member 42 comprises rib 46 and curved plate 44 and one end of said curved guide member 42 near said gripper means 40 is swingably supported by the cylinder and other end, by way of link member 52 which is forced by spring member 58, is also supported by the cylinder.
